(19) United States
(12) Patent Application Publication
(10) Pub. No.: US 2025/0170521 A1
(43) Pub. Date: May 29, 2025

(54) PROCESS AND APPARATUS FOR SEPARATING WASTE GAS FROM A FERROUS METAL PRODUCTION UNIT

(71) Applicant: L'Air Liquide, Societe Anonyme pour l'Etude et l’Exploitation des Procedes Georges Claude, Paris (FR)

(72) Inventors: Pascal MARTY, Paris (FR); Guillaume RODRIGUES, Paris (FR); Laurette MADELAINE, Paris (FR)

(21) Appl. No.: 18/955,906

(22) Filed: Nov. 21, 2024

(30) Foreign Application Priority Data
Nov. 24, 2023 (FR) 2313008

(51) Int. Cl. B01D 53/22; B01D 53/00; B01D 53/047

(52) U.S. Cl. CPC B01D 53/229; B01D 53/002; B01D 53/047; B01D 2256/20; B01D 2257/504; B01D 2258/025

(57) ABSTRACT

In a process for separating waste gas from a ferrous metal production unit, the waste gas is compressed in a first compressor (C) and then separated by pressure swing adsorption in an adsorption unit to produce a carbon monoxide-depleted and CO2-enriched gas relative to the waste gas and a first carbon monoxide-enriched and CO2-depleted gas relative to the waste gas, the CO2-enriched gas is sent to a unit (CC) for separation by partial condensation and/or distillation which produces a CO2-rich fluid (PL) containing at least 80 mol % of CO2 and at least one portion of the first CO-enriched gas is separated by permeation (M) to form a second CO2-enriched gas relative to the first CO-enriched gas at a first pressure and a gas richer in CO than the at least one portion of the first CO-enriched gas.

### CROSS-REFERENCE TO RELATED APPLICATIONS

This application claims the benefit of priority under 35 U.S.C. § 119 (a) and (b) to French patent application No. FR 2313008, filed Nov. 24, 2023, the entire contents of which are incorporated herein by reference.

### BACKGROUND

### Field of the Invention

The present invention relates to a process and an apparatus for separating waste gas from a ferrous metal production unit.

### Related Art

A process for producing cast iron in a smelting reactor such as a blast furnace is a process in which at least iron ore, an oxidizer and a fuel are introduced into the blast furnace so as to melt the ore and obtain cast iron containing at most 5% carbon, in which gases (so-called “blast furnace gases”) are recovered at the reactor outlet, containing, on a dry basis, from 15 to 45 mol % of CO2, from 15 to 45 mol % of CO or even 20 to 30 mol % of CO, the balance consisting essentially of nitrogen, hydrogen, various hydrocarbons and a small percentage of argon, and the CO2 is then separated from the rest of the blast furnace gas, the latter being sent to means for utilizing said gas. Preferably, the blast furnace gases comprise from 15 to 30 mol % of CO and/or CO2, each on a dry basis.

The blast furnace is an iron- and steel-making tool which produces cast iron from a charge of iron ore and coke, the oxidizer of the combustion being air optionally enriched with oxygen. The iron ore is heated, reduced and melted by the coke, whose combustion with air provides some of the energy needed to heat and melt the iron ore.

It is of course possible, in addition to the coke, to use coal or another hydrocarbon injected at the level of the tuyeres of the blast furnace. On the other hand, carbon monoxide is produced, resulting from the combustion reaction of coke and/or coal and/or hydrocarbon with the air known as blast which is injected into said tuyeres, enriched or not with oxygen. This carbon monoxide is necessary for the reduction of iron ore. The annual production of cast iron in a blast furnace can reach a hundred thousand tonnes for the smallest of them and several million tonnes for the most productive.

In the same plant, it is possible to have one or more blast furnaces, possibly up to ten on certain sites. Because of the combustion and the reactions generated in the blast furnace, a so-called blast furnace gas is recovered at the outlet of the blast furnace, and is a mixture typically of nitrogen (between about 35 and 65 percent by volume), which comes essentially from the air injected into the blast furnace nozzles, carbon monoxide (between about 15 and 30 mol %) and carbon dioxide (also between about 15 and 30 mol %), resulting from the partial or total combustion of the coke or in general the fuel injected.

This combustion is also the cause of water vapour being present, since the general reaction between a carbon-containing product and oxygen during combustion essentially produces CO2 and H₂O. Other gases are also found in the blast furnace gas, in an overall lesser quantity, generally less than the overall quantity of 12 percent by volume, these other gases consisting in particular of hydrogen, various hydrocarbons, argon from the air, etc. This blast furnace gas is a so-called “lean” gas because it has a low calorific value, typically of between 2000 and 6000 KJ/Nm³, as opposed to other iron- and steel-making gases referred to as “rich” because they have a much higher calorific value (for example, gases from a cast iron-to-steel converter or a coke oven, having calorific values typically of between 6000 and 10 000 KJ/Nm³ and between 12 000 and 20 000 KJ/Nm³, respectively).

In general, the quantity of gas produced by a blast furnace is very large and of the order of about 1500 Nm³ of gas per tonne of cast iron produced.

The result is that, given the composition of said gas, the quantity of carbon dioxide produced per tonne of cast iron is also very large: for example, for a blast furnace gas with an average carbon dioxide content of 22 percent in the dry gas and for a blast furnace producing one million tonnes of cast iron per year, the quantity of carbon dioxide emitted in the blast furnace gases is 330 million Nm³ per year, or about 650 000 tons of carbon dioxide produced in one year. For a blast furnace that produces 3 million tonnes of cast iron per year, the quantity of CO2 emitted is about 2 million tonnes per year, while for a site that produces 7 million tonnes of cast iron per year, the quantity of CO2 is about 4.5 million tonnes.

These quantities are quite considerable and, given the negative effect of these gases with respect to the atmosphere and the environment, it is not possible to contemplate sending them directly into the atmosphere in this way. Furthermore, discharging said gases into the atmosphere would also entail sending carbon monoxide into the atmosphere, which is known to be very dangerous, and it is therefore necessary to provide systems for recovering this blast furnace gas.

The typical composition of an example of a waste gas from a ferrous metal production unit (after cooling and extraction of condensed water vapour), here a blast furnace gas or “top gas”, is as follows:
H2: 4-5 mol %.
CO: 24-25%
CO2: 23-25%
N2: 40-45%
H2O: 3%

The aim of the extractions of the CO2 and N2 present in the top gases from blast furnaces is to upgrade the CO-rich product:
as fuel (higher calorific value) to turbines (electricity generation for an integrated steel mill) or to other users of the steel mill (such as cowpers, mixed with other fuel gases (coke oven gas, hydrocarbons, e.g. natural gas) to preheat the enriched air)
as reducing gas for the coal in the blast furnace itself

It is also known practice to use the CO-rich gas from a blast furnace gas as a raw material for the production of biofuels (for example the Steelanol® process to convert CO into at least one biofuel, for example bioethanol).

### SUMMARY OF THE INVENTION

According to the invention, a process is provided for separating waste gas from a ferrous metal production unit in the form of a blast furnace, in which:
i) the waste gas contains at least CO, CO2, hydrogen and nitrogen, of which between 15-45 mol % or even between 15-30 mol % is CO, on a dry basis, and is compressed in a first compressor and then separated by pressure swing adsorption in an adsorption unit to produce a carbon monoxide-depleted and CO2-enriched gas relative to the waste gas and a first carbon monoxide-enriched and CO2-depleted gas relative to the waste gas
ii) the CO2-enriched gas is sent to a unit for separation by partial condensation and/or distillation and/or solidification which produces a CO2-rich fluid containing at least 80 mol % of CO2
iii) at least one portion of the first CO-enriched gas is separated by permeation to form a second CO2-enriched gas relative to the first CO-enriched gas at a first pressure and a gas richer in CO than the at least one portion of the first CO-enriched gas.

According to other, optional features:
the at least one portion of the first CO-enriched gas is separated by permeation carried out at ambient temperature, the CO2-enriched gas relative to the CO-enriched gas being the permeate.
the at least one portion of the first CO-enriched gas is separated by permeation carried out at a temperature between 10° C. above the exit temperature from the adsorption unit and 10° C. below the exit temperature from the adsorption unit.
the at least one portion of the first CO-enriched gas is separated by permeation carried out at a temperature below the exit temperature from the adsorption unit, e.g. below 0° C. and above −52° C., preferably between −10° C. and −40° C., the CO2-enriched gas relative to the CO-enriched gas being the permeate.
the at least one portion of the first CO-enriched gas is separated by permeation carried out at a temperature above 50° C. and below 100° C., the CO-enriched gas being heated upstream of the permeation and the CO2-enriched gas relative to the CO-enriched gas being the permeate.
the gas richer in CO than the at least one portion of the first CO-enriched gas is sent to a process for producing biofuel, for example ethanol, by fermentation.
the gas sent to the process for producing biofuel, for example ethanol, contains less than 3 mol % of CO2.
the gas sent to the process for producing biofuel, for example ethanol, contains hydrogen and/or nitrogen and/or carbon monoxide
at least one portion of the second CO2-enriched gas is separated in the separation unit of step ii).
the at least one portion of the second CO2-enriched gas is compressed in a compressor with the CO2-enriched gas.
the at least one portion of the first CO-enriched gas is cooled upstream of the permeation by heat exchange with a fluid from the unit for separation by partial condensation and/or distillation and/or solidification.
the first carbon monoxide-enriched and CO2-depleted gas relative to the waste gas contains at least 80% or even at least 85% of the carbon monoxide present in the waste gas separated in the adsorption unit
at least one hydrogen- and/or carbon monoxide-enriched gas relative to the carbon monoxide-depleted and CO2-enriched gas is produced by the unit for separation by partial condensation and/or distillation and/or solidification and is sent to the adsorption unit for separation therein.

According to another subject of the invention, a waste gas separation apparatus is provided connected to a ferrous metal production unit comprising a blast furnace, a first compressor connected to compress a blast furnace waste gas containing at least CO, CO2, hydrogen and nitrogen, a pressure swing adsorption unit connected to the outlet of the first compressor, without passing through means for separation by permeation, the adsorption unit being configured to separate the compressed waste gas to produce a carbon monoxide-depleted and CO2-enriched gas relative to the waste gas and a first carbon monoxide-enriched and CO2-depleted gas relative to the waste gas, a unit for separation by partial condensation and distillation, a line connected to the adsorption unit and to the unit for separation by partial condensation and distillation to send the first CO2-enriched gas from the adsorption unit to a unit for separation by partial condensation and distillation, a permeation unit, a line connected to discharge a CO2-rich fluid containing at least 80 mol % of CO2 from the separation unit and a line for sending at least one portion of the CO-enriched gas from the adsorption unit to the permeation unit, the permeation unit being configured to form a second CO2-enriched gas relative to the first CO-enriched gas at a first pressure and a gas richer in CO than the at least one portion of the CO-enriched gas.

The apparatus may comprise:
means for heating or cooling the at least one portion of the CO-enriched gas upstream of the permeation unit.
a line for sending at least one portion of the second CO2-enriched gas to be separated in the separation unit.
a compressor for compressing the at least one portion of the second CO2-enriched gas and the CO2-enriched gas.

### BRIEF DESCRIPTION OF THE FIGURES

The invention will be described in more detail with reference to the figures, in which:

FIG. 1 represents a comparative process.

FIG. 2 represents a comparative process.

FIG. 3 represents a process according to the invention.

### DETAILED DESCRIPTION OF THE INVENTION

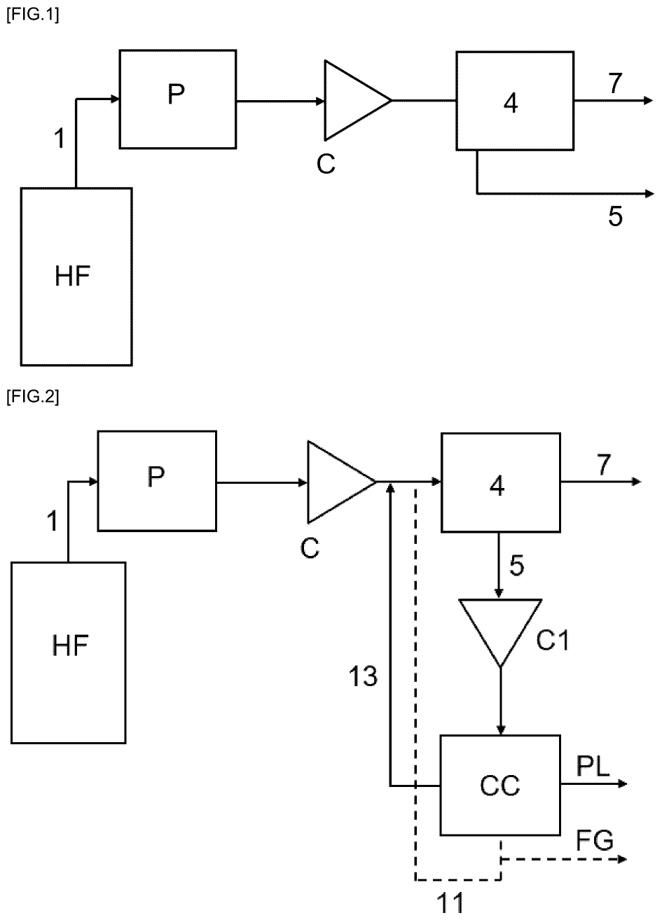

FIG. 1 illustrates a process for separating a top gas produced by a blast furnace HF which is purified in a pretreatment unit P to remove the dusts it contains, compressed by a compressor C and separated by pressure swing adsorption in a separation unit 4, without having been separated by permeation upstream of the unit 4, to produce a gas enriched in CO and nitrogen and depleted in CO2 7 relative to the gas 1 to be separated and a gas depleted in CO and nitrogen and enriched in CO2 5 relative to the gas to be separated.

In the case of a unit for separation by pressure swing adsorption, known as PSA, which processes a waste gas from a ferrous metal unit compressed to approximately 8 bar and is operated in “high CO yield” mode, the yield for recovery of CO at high pressure in the gas 7 is typically greater than 80% (or even greater than 85%) for corresponding yields of low-pressure CO₂ extraction in the gas 5 at around 88% and N₂ yields of 15%. It is sought both to maximize the yield for recovery of CO and the yields for extraction of CO2/N2.

The CO-rich stream 7 generated by the PSA 4 thus also contains a lot of nitrogen (about 85 mol % of the flow of gas treated) because the CO/N₂ selectivity is very low on conventional adsorbents. It also contains hydrogen and CO₂ (about 12% of the flow of gas treated).

The CO₂-rich gas produced at low pressure by the PSA also contains non-adsorbed CO (about 15% of the flow of top gas treated), H₂, nitrogen and the water present in the top gas.

[TAB1] represents an example of a material balance obtained for a single PSA 4 operating in “high CO yield” mode on waste gas 1 at about 8 bar as illustrated in [FIG. 1]:

| | PSA | CO-enriched | CO2-enriched |
|---|---|---|---|
| | 4 entry | gas 7 | gas 5 |
| Flow rate | 100 | 67 | 33 |
| H2 mol % | 5 | 8 | 1 |
| CO | 25 | 32 | 11 |
| CO2 | 26 | 5 | 68 |
| N2 | 43 | 55 | 18 |
| H2O | 1 | 0 | 2 |

CO recovery yield=85.8%

It is known practice to separate the CO2-enriched gas produced at low pressure by adsorptive separation of a top gas from a ferrous metal unit, for example by partial condensation and/or distillation. These two technologies can be integrated by recycling all or part of the stream of gas depleted in CO2 and containing CO originating from the separation by partial condensation and/or distillation in a separation unit CC upstream or downstream of the compressor of the gas C feeding the PSA 4, saving 10% or more of the compression energy of the PSA 4 (for the production of a constant partial flow of CO at the outlet of the PSA 4). This integration also makes it possible to increase the CO purity of the product HP of the PSA 4.

[TAB.2] shows the example of a material balance obtained for a PSA 4 operating in “high CO yield” mode on the waste gas 1 from a blast furnace HF at about 8 bar combined with a unit CC for separation by partial condensation and/or distillation and/or solidification:

| | PSA | CO-enriched | CO2- |
|---|---|---|---|
| | entry | gas (product) | enriched gas |
| Flow rate | 100 | 80 | 20 |
| H2 mol % | 5 | 7 | 0 |
| CO | 25 | 31 | 0.5 |
| CO2 | 26 | 7 | 99 |
| N2 | 43 | 55 | 0.5 |
| H2O | 1 | 0 | 0 |

The yield for CO recovery is in this case close to 100%, owing to the sending of at least one gas enriched in hydrogen and/or carbon monoxide relative to the carbon monoxide-depleted and CO2-enriched gas from the unit CC to the PSA 4.

It is possible to operate the PSA on “top gas” 1 in “high CO2 yield” mode with a degraded yield for CO recovery, which enables an increase in the yield for CO2 extraction. This functioning can be obtained by modifying the cycle of the PSA and/or by altering the quality of the adsorbents and/or by allowing less CO2 to enter the CO-rich gas.

Example of yields that can be obtained by a PSA on top gas at 8 bar:

TABLE 3

| PSA | | High | High |
|---|---|---|---|
| MODE | | CO yield | CO2 production |
| CO yield | % | 85 | 80 |
| N2 yield | % | 86 | 82 |
| CO2 yield | % | 13 | 2 |
| H2 yield | % | 94 | 93 |

Operating in “high CO2 production” mode may result in a CO-rich flow containing less than 2 mol % of CO2. On the other hand, a decrease in the partial flow rate of CO produced and therefore in the yield of CO recovery will be observed.

The coupling of a CO2 PSA as illustrated in [FIG. 2] with a separation by partial condensation and/or distillation CC has the following joint objectives:
to enrich the PSA waste gas with CO2 in order to minimize the specific energy of the CO2 separation process by partial condensation and/or distillation and/or solidification.
to increase the CO purity of a PSA product that can be sent to a carbon monoxide-consuming process, such as a fermentative CO-to-ethanol conversion process that utilizes CO.

The CO2-enriched gas 5 is sent to a partial condensation and/or distillation and/or solidification unit CC as described in the FR patent application. The unit CC produces a CO2-rich fluid PL containing at least 80 mol % of CO2 and a gas 13 enriched in at least one impurity lighter than CO2, for example carbon monoxide and hydrogen. The gas 13 is recycled upstream of the PSA adsorption unit.

The gas 5 can be compressed in a compressor C1 upstream of the unit CC.

The gas 5 can be dried upstream of the unit CC in dryers, for example by temperature swing adsorption. The gas used to regenerate the dryers can then be used as fuel gas FG and/or recycled upstream of the PSA as gas 11.

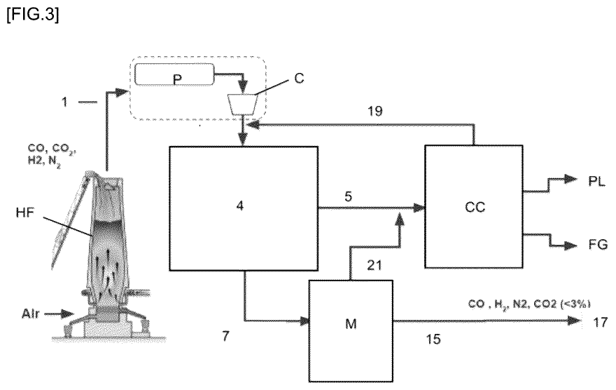

According to a variant of [FIG. 2], [FIG. 3] illustrates a process in which the CO2-depleted and CO-enriched gas 7 from the adsorption unit 4 is separated by permeation in the permeation unit M.

Maximization of the CO yield of the PSA 4 can be sought while trying to obtain a waste gas 5 from PSA 4 that is richer in CO2, thus decreasing the specific energy of the separation by partial condensation and/or distillation and/or solidification CC. The main benefit of operating the PSA 4 in “high CO yield” mode is to increase the CO2 concentration in the waste gas 5 from the PSA 4, the latter being the flow fed to the apparatus for separation by partial condensation and/or distillation and/or solidification CC. This optimization has the advantage of decreasing the OPEX, and to a lesser extent the CAPEX, of the apparatus for separation by partial condensation and/or distillation and/or solidification CC.

Such an adjustment of the PSA 4 can be obtained by modifying the PSA cycle and/or by acting on the quality of the adsorbents and/or by allowing more CO2 to enter the CO-rich gas 7. The CO2 contained in this gas 7 available at 8-9 bar can be largely removed by adding a permeative separation step in a permeation unit M as indicated in FIG. 3. The membranes used can be of the PI membrane type operated at temperatures below 0° C. or PoroGen® fibre membranes, allowing for example the removal of more than 70% of the CO2 while losing only 5% of the CO. The permeate 21 of these membranes M will be a stream very rich in CO2 and at low pressure, which can be recycled upstream of the separation by partial condensation and/or distillation and/or solidification CC for recovery.

The membrane unit M installed downstream of the PSA 4 will separate the CO-enriched flow 7 in order to generate two streams:
1-a first high-pressure stream 15 (residue) rich in CO and N2 and containing a small proportion of CO2. The reduction of CO2 in this stream thus offers the possibility of supplying a customer 17 looking for a CO-rich product, for example to increase the productivity of a fermentation process 17 that consumes CO in the gas to produce ethanol or other fuel.
2-a second low-pressure stream 21 (permeate), very rich in CO2, which is sent to the entry of the separation by partial condensation and/or distillation and/or solidification CC, allowing recovery of the CO and H2 contained in this permeate.

Four types of membrane separation applications can be considered:

### 1) Separation at Ambient Temperature

At least one portion of the CO-enriched gas 7 produced by the PSA 4 is separated by permeation carried out at the ambient temperature in the membrane unit M, the CO2-enriched gas 21 relative to the CO-enriched gas 7 being the permeate. This is possible by using membranes that are more selective for CO2 than for CO.

Examples of a suitable membrane are P-Guard or D-Guard or R-Guard from PoroGen Corporation or PI-1 or PI-2 from Medal.

### 2) Separation at a Temperature Below the Operating Temperature of the Adsorption Unit 4 (Preferable Mode)

At least one portion of the CO-enriched gas 7 is separated by permeation M carried out at a temperature below the operating temperature of the adsorption unit 4, for example below 0° C. and above −52° C., preferably between −15° C. and −35° C., the CO2-enriched gas 21 relative to the CO-enriched gas 7 being the permeate. An example of a suitable membrane is PI-1 or PI-2 from Medal.

At least one portion of the CO-enriched gas 7 is cooled upstream of the permeation M by a cold fluid from the unit for separation by partial condensation and/or distillation and/or solidification CC.

### 3) Separation at a Temperature Above 50° C. and Below 100° C.

At least one portion of the CO-enriched gas 7 is separated by permeation M carried out at a temperature above 50° C. and below 100° C., the CO-enriched gas 7 being heated upstream of the permeation and the CO2-enriched gas 21 relative to the CO-enriched gas being the permeate.

An example of a suitable membrane is G5 or Pix at Medal.

### 4) Separation at a Temperature Between 10° C. Above the Adsorption Unit Exit Temperature and 10° C. Below the Adsorption Unit Exit Temperature.

An example of a suitable membrane is P11-P12 at Medal.

A product 15 of the permeative separation M, according to one of the four types, is depleted in CO2 relative to the CO-enriched gas and is sent to a fermentative ethanol production process 17. The gas 15 contains preferably less than 3 mol % of CO2.

In this example, no portion of the CO-enriched gas 7 is returned to the blast furnace HF.

At least one portion of the second CO2-enriched gas 21 produced by the permeation M is separated in the separation unit CC to recover the CO2 contained therein. It may optionally be compressed in a compressor with the first gas.

The blast furnace HF of [FIG. 3] may be supplied with air or oxygen.

At least one gas enriched in hydrogen and/or carbon monoxide relative to the carbon monoxide-depleted and CO2-enriched gas is produced by the unit for separation by partial condensation and/or distillation and/or solidification, for example the gas FG. This gas or these gases can be sent to the adsorption unit 4 for separation therein.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

What is claimed is:

1. A process for separating waste gas from a ferrous metal production unit in the form of a blast furnace, comprising:
i) compressing the waste gas containing at least CO, CO2, hydrogen and nitrogen, of which between 15-45 mol % or even between 15-30 mol % is CO, on a dry basis, in a first compressor, thereby producing a compressed waste gas stream, and then separating the compressed waste gas stream by pressure swing adsorption in an adsorption unit thereby producing a carbon monoxide-depleted and CO2-enriched gas relative to the waste gas and a first carbon monoxide-enriched and CO2-depleted gas relative to the waste gas,
ii) separating the CO2-enriched gas in a unit for separation by partial condensation and/or distillation and/or solidification which produces a CO2-rich fluid containing at least 80 mol % of CO2
iii) separating at least one portion of the first CO-enriched gas by permeation to form a second CO2-enriched gas relative to the first CO-enriched gas at a first pressure and a gas richer in CO than the at least one portion of the first CO-enriched gas.

2. The process of claim 1, wherein the at least one portion of the first CO-enriched gas is separated by permeation carried out at ambient temperature, the CO2-enriched gas relative to the CO-enriched gas being the permeate.

3. The process of claim 1, wherein the at least one portion of the first CO-enriched gas is separated by permeation carried out at a temperature between 10° C. above the exit temperature from the adsorption unit and 10° C. below the exit temperature from the adsorption unit.

4. The process of claim 1, wherein the at least one portion of the first CO-enriched gas is separated by permeation carried out at a temperature below the exit temperature from the adsorption unit, the CO2-enriched gas relative to the CO-enriched gas being the permeate.

5. The process of claim 1, wherein the at least one portion of the first CO-enriched gas is separated by permeation carried out at a temperature above 50° C. and below 100° C., the first CO-enriched gas being heated upstream of the permeation and the CO2-enriched gas relative to the first CO-enriched gas being the permeate.

6. The process of claim 1, wherein the gas richer in CO than the at least one portion of the first CO-enriched gas is sent to a process for producing biofuel by fermentation.

7. The process of claim 6, wherein the gas sent to the process for producing biofuel contains less than 3 mol % of CO2.

8. The process of claim 1, wherein at least one portion of the second CO2-enriched gas is separated in the separation unit of step ii).

9. The process of claim 8, wherein the at least one portion of the second CO2-enriched gas is compressed in a compressor with the CO2-enriched gas.

10. The process of claim 3, wherein the at least one portion of the first CO-enriched gas is cooled upstream of the permeation by heat exchange with a fluid from the unit for separation by partial condensation and/or distillation and/or solidification.

11. The process of claim 1, wherein at least one hydrogen- and/or carbon monoxide-enriched gas relative to the carbon monoxide-depleted and CO2-enriched gas is produced by the unit for separation by partial condensation and/or distillation and/or solidification and is sent to the adsorption unit for separation therein.

12. A waste gas separation apparatus connected to a ferrous metal production unit comprising a blast furnace, a first compressor connected to compress a blast furnace waste gas containing at least CO, CO2, hydrogen and nitrogen, a pressure swing adsorption unit connected to the outlet of the first compressor, without passing through means for separation by permeation, the adsorption unit being configured to separate the compressed waste gas to produce a carbon monoxide-depleted and CO2-enriched gas relative to the waste gas and a first carbon monoxide-enriched and CO2-depleted gas relative to the waste gas, a unit for separation by partial condensation and distillation, a line connected to the adsorption unit and to the unit for separation by partial condensation and distillation to send the first CO2-enriched gas from the adsorption unit to a unit for separation by partial condensation and distillation, a permeation unit, a line connected to discharge a CO2-rich fluid containing at least 80 mol % of CO2 from the separation unit and a line for sending at least one portion of the CO-enriched gas from the adsorption unit to the permeation unit, the permeation unit being configured to form a second CO2-enriched gas relative to the first CO-enriched gas at a first pressure and a gas richer in CO than the at least one portion of the CO-enriched gas.
